(19) United States
(12) Patent Application Publication
(10) Pub. No.: US 2011/0063013 A1
(43) Pub. Date: Mar. 17, 2011

(54) MIXER CIRCUIT

(75) Inventors: Young-Jin Kim, Seongnam City (KR); Il-Ho Na, Seongnam City (KR); Chun-Sik Jeong, Seongnam City (KR); Seong-Young Son, Seongnam City (KR); Seung-Min Lee, Seongnam City (KR); Myung-Woon Hwang, Seongnam City (KR)

(73) Assignee: FCI INC., Gyeonggi-do (KR)

(21) Appl. No.: 12/868,003

(22) Filed: Aug. 25, 2010

(30) Foreign Application Priority Data
Sep. 17, 2009 (KR) 10-2009-0087958

(51) Int. Cl. G06G 7/12

(52) U.S. Cl. 327/355

(57) ABSTRACT

The present invention discloses a mixer circuit for mixing two input signals by source-coupled MOS transistors and outputting a mixed result. A duty cycle controlling MOS transistor is connected to a source of each source-coupled MOS transistor in series. A duty cycle controlling pulse is applied to a gate of the duty cycle controlling MOS transistor. The duty cycle controlling pulse has a phase shift of −90 degrees with respect to a controlling pulse applied to the gate of the source-coupled MOS transistor connected with the duty cycle controlling MOS transistor in series. An AND-combination of the duty cycles of the two controlling pulses applied to the gates of the two MOS transistors connected in series can be controlled at 25%. Comparing to the conventional mixer circuit having a switch control duty cycle of 50%, the present invention achieves the effects of increasing the gain and reducing the noise figure.

### CLAIM OF PRIORITY

This application claims priority to Korean Patent Application No. 10-2009-0087958 filed on Sep. 17, 2009.

### TECHNICAL FIELD OF THE INVENTION

The present invention relates to a mixer circuit for radio frequency (RF) transceiver, more particularly, to a mixer circuit which is able to reduce a noise figure (NF) due to turning on and off of a triode. The mixer circuit of the present invention can optimize the NF.

### BACKGROUND OF THE INVENTION

In a general case, an RF transceiver uses a mixer circuit to mix an input signal and a base signal to get a mixed signal. An intermediate frequency (IF) signal obtained from the mixed signal is demodulated. Alternatively, the mixed signal is carried with IF so as to be used in demodulation. At this time, a triode that is turned on and off by the mixer circuit will generate a noise figure (NF).

FIG. 1 shows a structure of a general mixer circuit.

As shown, the mixer circuit is composed of the following two circuits: a first mixing circuit and a second mixing circuit. In the first mixing circuit, two input signals (MIX_IP), (MIX_IN) pass through two pairs of source-coupled MOS transistors (M1, M2), (M3, M4), a first output signal (IF_IP) and a second output signal (IF_IN) with a phase shift of 0 degree and 180 degrees, respectively, are generated. In the second mixing circuit, the two input signals (MIX_IP), (MIX_IN) pass through two pairs of source-coupled MOS transistors (M5, M6), (M7, M8), a third output signal (IF_QP) and a fourth output signal (IF_QN) with a phase shift of −90 degrees and −270 degrees, respectively, are generated.

The first mixing circuit 1 has a structure as described below. Both the first and second MOS transistors M1, M2, which are connected as a pair, have a first input signal MIX_INP inputted to the source terminals thereof. Both the third and fourth MOS transistors M3, M4, which are also connected as a pair, have a second input signal MIX_INN inputted to the source terminals thereof. The second and third MOS transistors M2, M3 have their drain terminals crossing each other and respectively connected with drain terminals of the first and fourth MOS transistors M1, M4, and then further connected to a first output terminal and a second output terminal IF_IP and IF_IN, respectively. The first and fourth MOS transistors M1, M4 have their gates connected in common with a first controlling pulse LO_IP. The second and third MOS transistors M2, M3 have their gates connected in common with a second controlling pulse LO_IN. The first and second controlling pulses LO_IP and LO_IN are generated by a controlling signal generator (not shown) and inputted for controlling a switch triode so as to control the switch timing of the first to fourth MOS transistors. The first controlling pulse LO_IP is set as a base pulse, that is, a signal with a zero phase shift. The second controlling pulse LO_IN has the phase shift of 180 degrees with respect to the base signal. That is, the second controlling pulse LO_IN is a controlling pulse with a reverse phase.

In addition, the second mixing circuit 2 has the same structure as the first mixing circuit 1. However, the gates of the fifth and eighth MOS transistors M5, M8 are applied with a third controlling pulse LO_QP, which has a phase shift of −90 degrees with respect to the first controlling pulse LO_IP. The gates of the sixth and seventh MOS transistors M6, M7 are applied with a fourth controlling pulse LO_QN, which has a phase shift of −270 degrees with respect to the first controlling pulse LO_IP.

The mixer circuit, which has the structure as described above, controls the switching of the MOS transistors M1 to M8 by using the first to fourth controlling pulses, and thereby generating the first to fourth output signals IF_IP, IF_IN, IF_QP, IF_QN with different phase shifts from the two input signals MIX_INP and MIX_INN.

However, the turning on and off of the switch triode of the mixer circuit will cause the occurrence of the NF.

FIG. 2 shows a relationship between a gain and the noise figure of a general mixer circuit.

In the mixer circuit, the gain does not dramatically change due to the duty cycle variance of the controlling pulse. The gain is in a stable status. However, it can be seen that the NF is the lowest in the section where duty cycle is 20%.

In the current mixer circuit, although the controlling pulses applied to the gates of the first to eighth MOS transistors M1 to M8 have different phase shifts, each controlling pulse is inputted at a constant status in which the duty cycle is 50%.

As shown in FIG. 2, for the current mixer circuit, the NF increases in the section where the duty cycle is 50%. Therefore, there is a problem of noises due to turning on and off the triode.

### SUMMARY OF THE INVENTION

An objective of the present invention is to provide a mixer circuit, which can solve the above problem of the current mixer circuit. The mixer circuit of the present invention can improves the noise figure (NF), so as to prevent occurrence of noises.

Another objective of the present invention is to provide a mixer circuit, in which a duty cycle for switch controlling is adjusted to be in the section of 20%, so as to minimize the NF.

A further objective of the present invention is to provide a mixer circuit, which can achieve reduction of switch controlling time by using a combination of current controlling pulses which are applied to gates of a switch triode without using additional controlling pulses. The mixer circuit of the present invention can improve the NF by a simple circuit structure.

To achieve the above objectives, the present invention provides a mixer circuit, which mixes two input signals by source-coupled MOS transistors and outputs a mixed signal. In the mixer circuit, each of the source-coupled MOS transistors is connected with a duty cycle controlling MOS transistor in series at a source terminal thereof. A gate of the duty cycle controlling MOS transistor is applied with a duty cycle controlling pulse, which has a phase shift of −90 degrees with respect to a controlling pulse applied to a gate of the source-coupled MOS transistor connected in series with the duty cycle controlling MOS transistor. In addition, an AND-combination of duty cycles of the controlling pulses applied to the gates of the two MOS transistors connected in series can be controlled at 25%.

In order to control the duty cycle as above, the mixer circuit in accordance with the present embodiment of the present invention is composed by a first mixing circuit and a second mixing circuit. In each of the mixing circuits, a first and a second input signals are respectively inputted to a source-coupled terminal. The drains of the MOS transistors of the source-coupled MOS transistor pairs cross each other, and are connected with the drains of the other source-coupled MOS transistor pairs and then connected with the first to fourth controlling pulses, respectively. By doing so, the first and second mixing circuits output a first, a second output signals, and a third, a fourth output signals. In the mixer circuit, a duty cycle controlling MOS transistor is connected in series between the source terminal of the source coupled MOS transistor and each input terminal. The gate of each duty cycle controlling MOS transistor is applied with a controlling pulse, which has a phase shift of −90 degrees with respect to the controlling pulse applied to the gate of the MOS transistor connected with the duty cycle controlling MOS transistor in series. The AND-combination of the gate controlling pulses of these two MOS transistors connected with each other in series is utilized to control the switch, so that the duty cycle is controlled to be in the section of 20%.

The mixer circuit in accordance with the present invention, the source of each source-coupled MOS transistor is connected with the duty cycle controlling MOS transistor in series, so as to control the duty cycle at 25%. Therefore, in comparison with the mixer circuit having the switch duty cycle of 50%, the present invention can achieve the effects of increasing gain and reducing NF.

### BRIEF DESCRIPTION OF THE DRAWINGS

The present invention will be described in detail in conjunction with the appending drawings, in which:

FIG. 1 shows a structure of a general mixer circuit;

FIG. 2 shows a relationship between a gain and the noise figure of a general mixer circuit;

FIG. 3 shows a circuitry of a mixer circuit in accordance with an embodiment of the present invention;

FIG. 4 is a timing chart showing the first to fourth controlling pulses and the duty cycle controlling pulses;

FIGS. 5a and FIG. 5b are simulation graphs respectively showing relationship between gain and duty cycle, relationship between the noise figure and duty cycle, of a mixer circuit, in which the duty cycle is controlled in according with the present invention;

FIG. 6 is a schematic diagram showing an application example of the mixer circuit in accordance with the present invention; and

FIG. 7 is an explanatory diagram showing an active mixer circuit in accordance with the present invention.

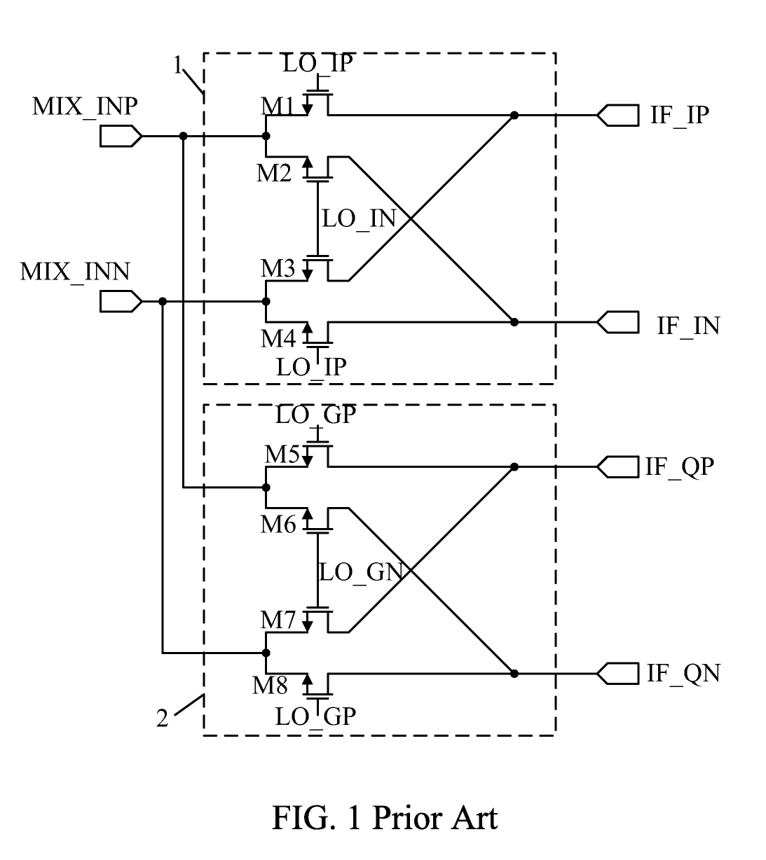

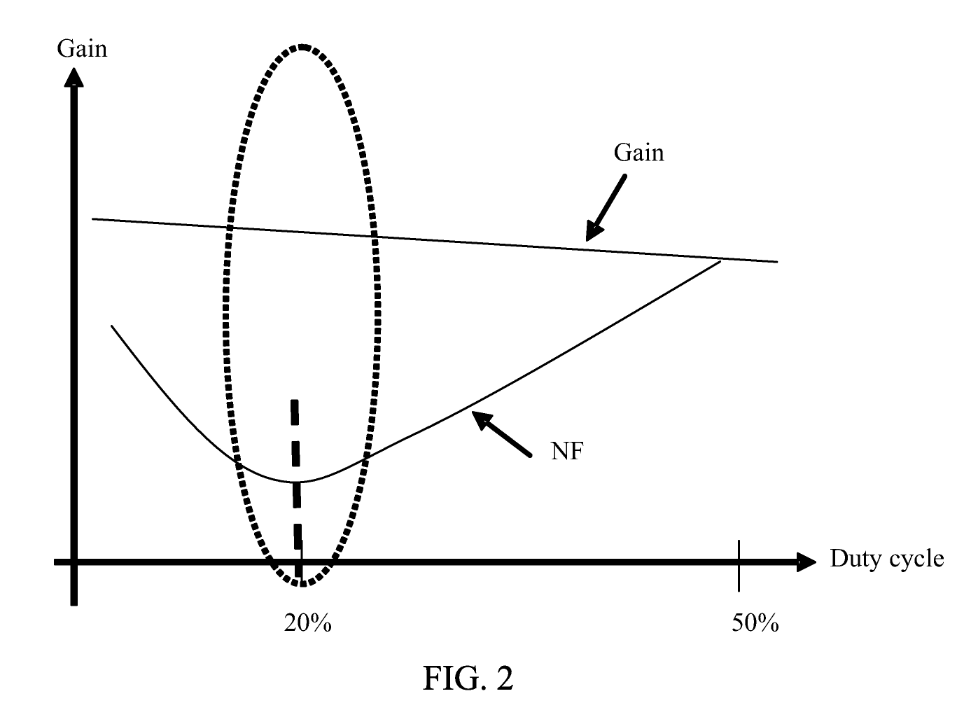

### DETAILED DESCRIPTION OF THE INVENTION

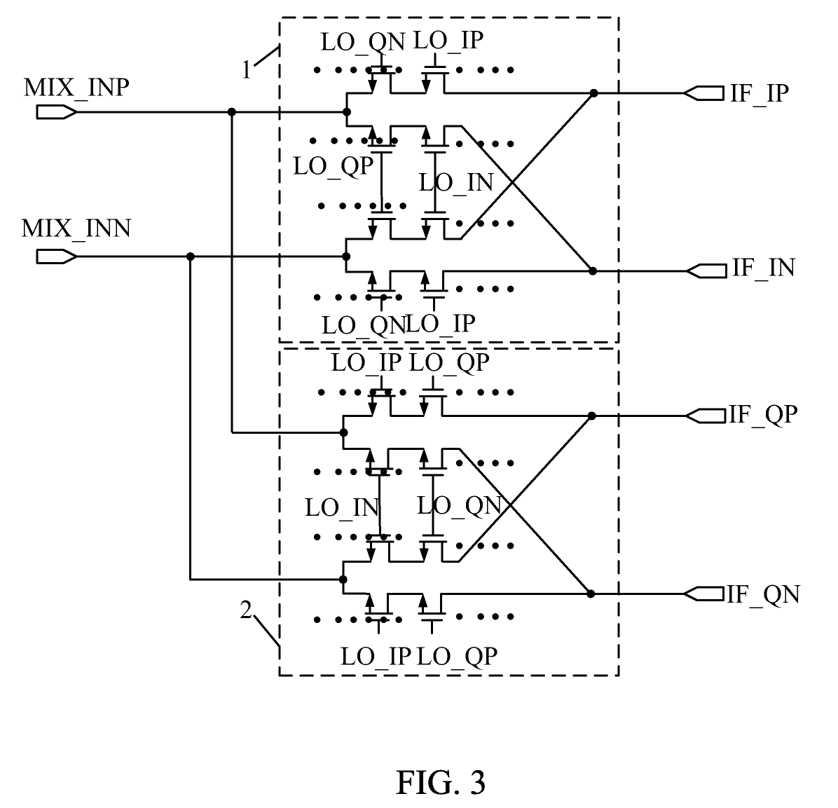

FIG. 3 shows a circuitry of a mixer circuit in accordance with an embodiment of the present invention.

As shown, the mixer circuit of the present invention includes a first mixing circuit 1 and a second mixing circuit 2. The latter has the same structure as the first mixing circuit 1. In the first mixing circuit 1, a first input terminal and a second input terminal MIX_INP, MIX_INN are respectively connected to a source-coupled terminal of a first MOS transistor and a second MOS transistor M1 and M2, which are connected as a pair in a source-coupled manner, and a source-coupled terminal of a third MOS transistor and a fourth MOS transistor M3 and M4, which are connected as a pair in a source-coupled manner. The drains of the second and third MOS transistors M2, M3 cross each other and then connected to a first output signal terminal and a second output signal terminal IF_IP, IF_IN in common with the drains of the first and fourth MOS transistors M1, M4, respectively. The gates of the first and fourth MOS transistors M1, M4 are connected with a first controlling pulse LO_IP. The gates of the second and third MOS transistors M2, M3 are connected to a reverse controlling pulse (i.e. a second controlling pulse) having a phase shift of 180 degrees with respect to the first controlling pulse. In the second mixing circuit 2, among a fifth to an eighth MOS transistors, the fifth MOS transistor and the eighth MOS transistor M5, M8 have their gates connected with a third controlling pulse LO_QP, and a sixth MOS transistor and a seventh MOS transistor M6, M7 have their gates connected with a fourth controlling pulse LO_QN. The second mixing circuit 2 outputs a third output signal IF_QP, which has a phase shift of −90 degrees with respect to the first output signal IF_IP, and a fourth output signal IF_QN, which has a phase shift of −270 degrees. In the mixer circuit, the source terminals of the first to eighth MOS transistors M1-M8 are connected with an eleventh to eighteenth MOS transistors M11-M18, respectively. The eleventh and twelfth MOS transistors M11, M12, and also the fifteenth and sixteenth MOS transistors M15, M16, are connected to the first input signal MIX_INP terminal in the source-coupled manner. The thirteenth and fourteenth MOS transistors M13, M14, and also the seventeenth and eighteenth MOS transistors M17, M18, are connected to the second input signal MIX_INN terminal in the source-coupled manner. The gates of the eleventh and fourteenth MOS transistors M11, M14 are connected with the fourth controlling pulse LO_QN, which has a phase shift of −270 degrees with respect to the first controlling pulse LO_IP. The gates of the twelfth and thirteenth MOS transistors M12, M13 are connected with the third controlling pulse LO_QP, which has a phase shift of −90 degrees with respect to the first controlling pulse LO_IP. The gates of the fifteenth and eighteenth MOS transistors M15, M18 are connected with the first controlling pulse LO_IP. The gates of the sixteenth and seventeenth MOS transistors M16, M17 are connected with the second controlling pulse LO_IN.

Although the mixer circuit of the embodiment of the present invention is composed of the first mixing circuit 1 and the second mixing circuit 2, the mixer circuit may only has the first mixing circuit 1 or the second mixing circuit 2. Since such a mixer circuit has the same structure as described above, the detailed description thereof is omitted herein. In addition, the controlling pulse is used to control the gate switch in the mixer circuit. The controlling pulse is usually generated by a controlling pulse generating means (not shown) in the mixer circuit, so as to control the switch triode of the mixer circuit. Description of the controlling pulse generation is omitted herein.

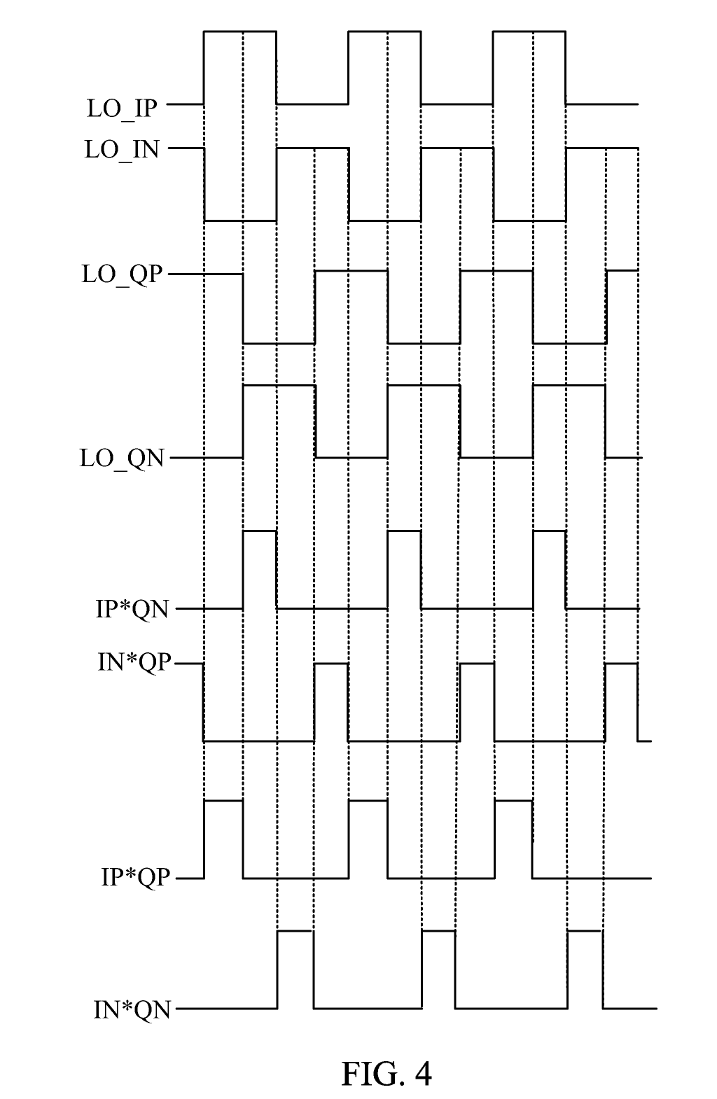

FIG. 4 is a timing chart showing the first to fourth controlling pulses and the duty cycle controlling pulses.

In the present invention, the duty cycle controlling MOS transistors M11 to M18 are connected in series to the respective source terminals of the general mixer circuit composed of the source-coupled MOS transistors (M1, M2), (M3, M4), (M5, M6), (M7, M8). The AND-combination of the gate pulses for the two MOS transistors connected in series is used to control the switch, and accordingly control the duty cycle.

The second controlling pulse LO_IN has a phase shift of 180 degrees with respect to the first controlling pulse LO_IP. That is, the second controlling pulse LO_IN has a reverse phase with respect to the first controlling pulse LO_IP. The third controlling pulse LO_QP has a phase shift of −90 degrees with respect of the first controlling pulse LO-IP. The fourth controlling pulse has a phase shift of −270 degrees with respect of the first controlling pulse LO-IP. The above four controlling pulses are the most commonly used controlling pulses in the first mixing circuit 1 and the second mixing circuit 2. According to the present invention, it needs neither to additionally use a means for generating the controlling pulses nor to complicatedly process the pulses. It needs only to apply the controlling pulses to the gates of the first and second mixing circuits, and adjust the connections, and then the duty cycle control can be achieved.

In the present invention, the source terminal of each source-coupled MOS transistor is connected in series with a duty cycle controlling MOS transistor (e.g. M11 to M18). In addition, the gate controlling pulse of each duty cycle controlling MOS transistor has a phase shift of −90 degrees with respect to the gate pulse for the MOS transistor connected therewith in series. By doing so, the switch duty cycle can be controlled by using the AND-combination of the gate pulses of the two MOS transistors connected in series.

The first controlling pulse LO_IP and the fourth controlling pulse LO_QN are inputted to the first MOS transistor M1 and the eleventh MOS transistor M11, respectively. The eleventh MOS transistor M11 and the first MOS transistor M1 are turned on signaling by using the duty cycle of IP*QN shown in FIG. 4, i.e. a pulse timing of 25% with respect to the duty cycle of the first controlling pulse. Signaling of the fourteenth MOS transistor M14 and the fourth MOS transistor M4 is switched by using the IP*QN timing shown in FIG. 4.

In addition, the fourth controlling pulse LO_QN and the second controlling pulse LO_IN are inputted to the twelfth MOS transistor M12 and the second MOS transistor M2, respectively. The twelfth MOS transistor M12 and the second MOS transistor M2 are switched to turn on signaling by using the duty cycle of IN*QN, which is 25%, as shown in FIG. 4. Signaling of the thirteenth MOS transistor M13 and the third MOS transistor M3 is turned on by using the IN*QN timing shown in FIG. 4.

Similarly, the fifteenth, fifth MOS transistors M15, M5 and the eighteenth, eighth MOS transistors M18, M8 are switched by using an AND-combination of the first controlling pulse LO_IP and the third controlling pulse LO_QP, i.e. the IP*QP duty cycle of 25% shown in FIG. 4. The sixteenth, sixth MOS transistors M16, M6 and the seventeenth, seventh MOS transistors M17, M7 are switched by using an AND-combination of the first controlling pulse LO_IN and the third controlling pulse LO_QN, i.e. the IN*QN duty cycle of 25% shown in FIG. 4.

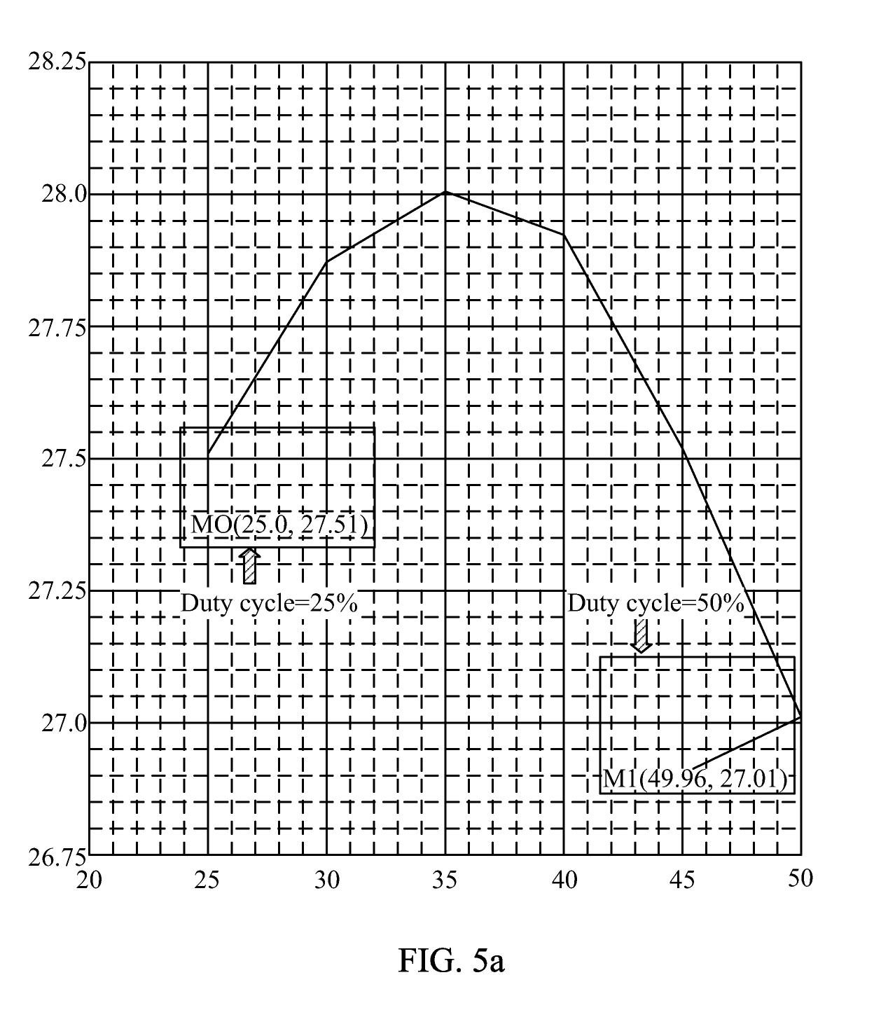

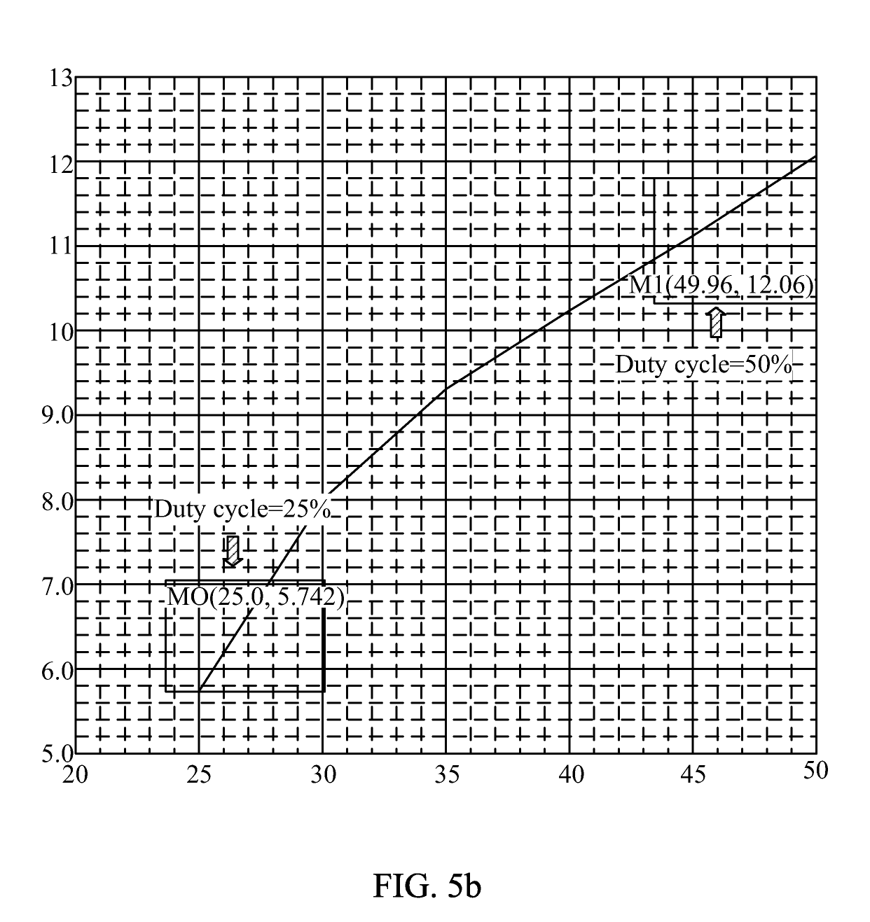

FIG. 5a and FIG. 5b are simulation graphs respectively showing relationship between gain and duty cycle, and relationship between the noise figure and duty cycle of a mixer circuit, of which the duty cycle is controlled in according with the present invention.

According to the present invention, the duty cycle controlling MOS transistors are connected to control the duty cycle for turning on each signal, as shown in FIG. 5a and FIG. 5b. As can be seen, the gain and noise figure change as the duty cycle varies. When the duty cycle of the controlling pulse is 25%, the gain increases with respect to the condition where the duty cycle is 50%, as shown in FIG. 5a; while the noise figure decreases as shown in FIG. 5b.

Therefore, in comparison with the conventional mixer circuit, the mixer circuit of the present invention is able to increase the gain or maintain the gain unchanged, and in the meanwhile to control the switching duty cycle to be at 25%, thereby significantly reducing the noise figure so as to improve the performance.

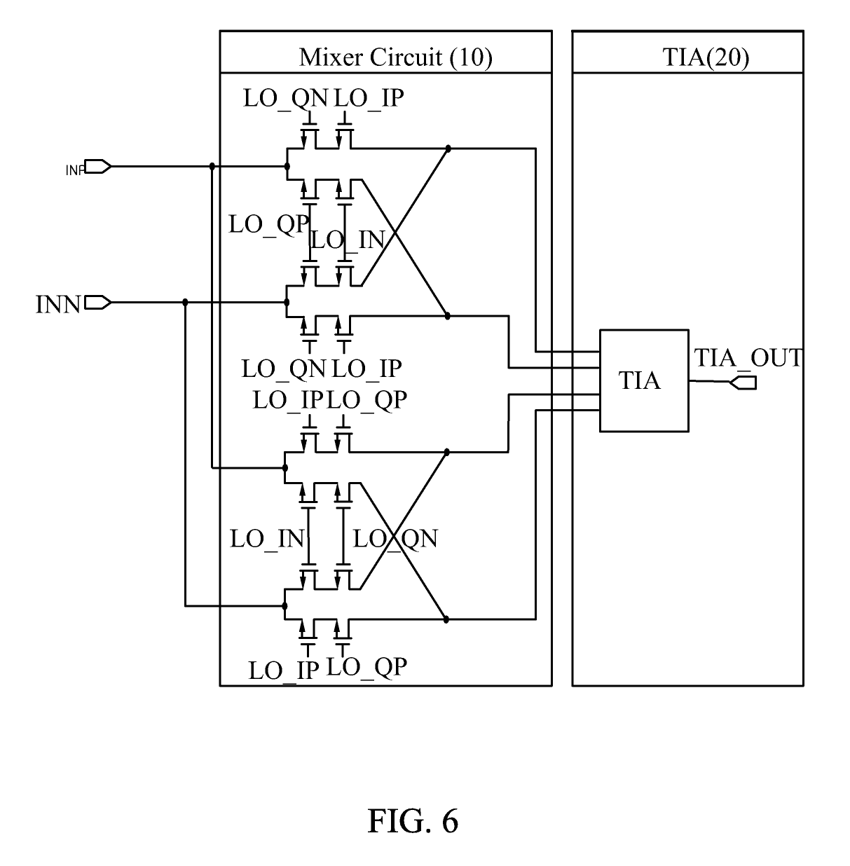

FIG. 6 is a schematic diagram showing an application example of the mixer circuit in accordance with the present invention. As shown, the mixer circuit 10 of the present invention is connected with a TIA (Trans-impedance Amplifier) 20. As described above, the mixer circuit 10 is connected in front of the TIA 20 of a transceiver (not shown). In comparison with the case in which a conventional mixer circuit with a duty cycle of 50% is used, a lower noise figure can be obtained by using the present invention, and therefore the performance can be improved.

Although the mixer circuit of the embodiment of the present invention shown in FIG. 3 is a passive mixer circuit, the present invention is not limited thereto. The present invention is also adaptable to an active mixer circuit.

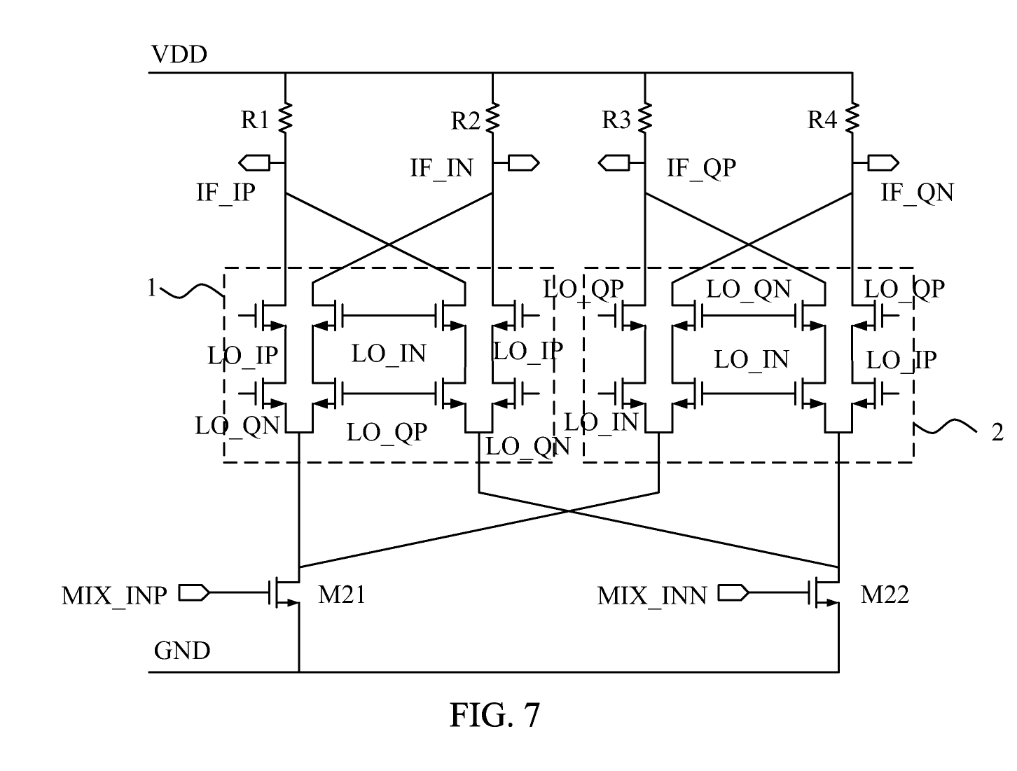

FIG. 7 is an explanatory diagram showing an active mixer circuit in accordance with the present invention. As shown, the first input signal MIX_INP and a reverse signal with respect of MIX_INP (i.e. the second input signal MIX_INN) are respectively inputted to gates of active elements, that is, NMOS transistors M21, M22. The source terminals of the NMOS transistors M21, M22 are connected to the system ground, and the drain terminals thereof are connected to the source-coupled terminals of the first and second mixing circuits 1 and 2, respectively. A power source voltage VDD is applied the each output terminal of the first and second mixing circuit 1 and 2, that is, the terminals IF_IP, IF_IN, IF_QP, IF_QN. The active mixer circuit is constructed as above.

As described above, this mixer circuit has the similar structure as the passive mixer circuit of FIG. 3 including the first mixing circuit 1 and the second mixing circuit 2. The active mixer circuit is constructed by inputting the mixer input signals to the gates of the NMOS transistors M21, M22. The input signals pass through the NMOS transistors M21, M22 and are inputted to the source-coupled terminals of the first and second mixing circuits 1, 2, In addition, the respective output terminals are biased by the power source voltage.

Therefore, the present invention can be adapted to not only the passive mixer circuit, but also the active mixer circuit.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A mixer circuit for mixing two input signals by source-coupled MOS transistors and then outputting output signals, said mixer circuit comprising:
duty cycle controlling MOS transistors, each being connected to a source terminal of the source-coupled MOS transistors in series, a duty cycle controlling pulse being applied to a gate of said duty cycle controlling MOS transistor, said duty cycle controlling pulse having a phase shift of −90 degrees with respect to a controlling pulse applied to a gate of one of said source-coupled MOS transistors which is connected with said duty cycle controlling MOS transistor in series,
wherein an AND-combination of duty cycles of said controlling pulses applied to the two MOS transistors connected with each other in series is controlled at 25%.

2. The mixer circuit as claimed in any one of claim 1, further comprising two NMOS transistors having gates thereof connected with a first input signal terminal and a second input signal terminal for inputting the two input signals, respectively, sources thereof being grounded, and drains thereof connected with the source-coupled terminals of the mixer circuit, wherein a power source voltage is applied to output signal terminals for outputting the output signals of the mixer circuit so as to construct an active mixer circuit.

3. A mixer circuit having a first and a second input signal terminals respectively connected with a source-coupled terminal of a first and second MOS transistors, which are connected with each other in a source-coupled manner as a pair, and a source-coupled terminal of a third and fourth MOS transistor, which are connected with each other in a source-coupled manner as a pair, drains of the second and third MOS transistors crossing each other and being connected with drains of the first and fourth MOS transistors, and then connected to a first output signal terminal and a second output signal terminal, respectively, gates of the first and fourth MOS transistors being connected with a first controlling pulse, gates of the second and third MOS transistors being connected with a second controlling pulse, which has a phase shift of 180 degrees with respect to the first controlling pulse,
wherein source terminals of the first to fourth MOS transistors are respectively connected with MOS transistors including eleventh to fourteenth MOS transistors in series, the eleventh and twelfth MOS transistors are source-coupled and then connected to the first input signal terminal, the thirteenth and fourteenth MOS transistors are source-coupled and connected to the second input signal terminal, gates of the twelfth and thirteenth MOS transistors are applied with a third controlling pulse having a phase shift of −90 degrees with respect to the first controlling pulse, gates of the eleventh and fourteenth MOS transistors are applied with a fourth controlling pulse having a phase shift of −270 degrees with respect to the first controlling pulse.

4. The mixer circuit as claimed in any one of claim 3, further comprising two NMOS transistors having gates thereof connected with the first input signal terminal and the second input signal terminal, respectively, sources thereof being grounded, and drains thereof connected with the source-coupled terminals of the mixer circuit, wherein a power source voltage is applied to the respective output signal terminals of the mixer circuit so as to construct an active mixer circuit.

5. A mixer circuit comprising:
a first mixing circuit, in which a first input signal terminal and a second input signal terminal being respectively connected to a source-coupled terminal of a first MOS transistor and a second MOS transistor formed as a pair in a source-coupled manner and a source-coupled terminal of a third MOS transistor and a fourth MOS transistor formed as a pair in the source-coupled manner, drains of the second MOS transistor and the third MOS transistor crossing each other and being connected with a first output signal terminal and a second output signal terminal with drains of the first MOS transistor and the fourth MOS transistor, respectively, gates of the first MOS transistor and the fourth MOS transistor being applied with a first controlling pulse, gates of the second MOS transistor and the third MOS transistor being connected with a second controlling pulse having a phase shift of 180 degrees with respect to the first controlling pulse; and
a second mixing circuit having the same structure as the first mixing circuit, the second mixing circuit comprising MOS transistors including fifth to eighth MOS transistors, gates of the fifth MOS transistor being applied with a third controlling pulse, gates of the sixth MOS transistor and the seventh MOS transistor being applied with a fourth controlling pulse, the second mixing circuit outputting a third output signal having a phase shift of −90 degrees with respect to the first controlling pulse and a fourth output signal having a phase shift of −270 degrees,
wherein source terminals of the first to eighth MOS transistors are connected with MOS transistors including eleventh to eighteenth MOS transistors, the eleventh and twelfth MOS transistors are source-coupled, the fifteenth and sixteenth MOS transistors are source coupled, the eleventh, twelfth, fifteenth and sixteenth MOS transistors are connected with the first input signal terminal, the thirteenth and fourteenth MOS transistors are source-coupled, the seventeenth and eighteenth MOS transistors are source coupled, the thirteenth, fourteenth, seventeenth and eighteenth MOS transistors are connected with the second input signal terminal, gates of the first and fourteenth MOS transistors are applied with the fourth controlling pulse having the phase shift of −270 degrees with respect to the first controlling pulse, gates of the twelfth and thirteenth MOS transistors are applied with the third controlling pulse having the phase shift of −90 degrees with respect to the first controlling pulse, gates of the fifteenth and eighteenth MOS transistors are applied with the first controlling pulse, and gates of the sixteenth and seventeenth MOS transistors are applied with the second controlling pulse.

6. The mixer circuit as claimed in any one of claim 5, further comprising two NMOS transistors having gates thereof connected with the first input signal terminal and the second input signal terminal, respectively, sources thereof being grounded, and drains thereof connected with the source-coupled terminals of the mixer circuit, wherein a power source voltage is applied to the respective output signal terminals of the mixer circuit so as to construct an active mixer circuit.
